(19) United States
(12) Patent Application Publication
(10) Pub. No.: US 2012/0181431 A1
(43) Pub. Date: Jul. 19, 2012

(54) Portable Terahertz Receiver for Advanced Chemical Sensing

(76) Inventors: Vladimir Mitin, Amherst, NY (US); Matthew Bell, Highland Park, NJ (US); Andrei Sergeyev, Snyder, NY (US); Aleksandr Verevkin, Highland Park, NJ (US)

(21) Appl. No.: 13/390,968

(22) PCT Filed: Aug. 19, 2010
(86) PCT No.: PCT/US2010/046005

§ 371 Date: Mar. 20, 2012

Related U.S. Application Data
(60) Provisional application No. 61/235,053, filed on Aug. 19, 2009.

(51) Int. Cl. G01J 5/20; G01J 5/10

(52) U.S. Cl. 250/338.4; 250/338.1; 250/352

(57) ABSTRACT

The present invention is directed to a system and method for advanced chemical sensing utilizing a Terahertz receiver instrument having a compact tunable heterodyne mixer to detect chemical species in a noisy background of pollutants, and provide fast acquisition and analysis of the 0.1-2 THz spectrum. The present invention directly couples a microbolometer with a THz quantum cascade laser (QCL) that is utilized as the local oscillator (LO) source for the receiver.

This invention was made with government support under IIP-0810485 awarded by National Science Foundation. The government has certain rights in the invention.

### FIELD OF THE INVENTION

The present invention generally relates to a system and method for advanced chemical sensing utilizing a Terahertz receiver instrument. A compact tunable heterodyne mixer provides support for a high resolution to allow the system to detect chemical species in a noisy background of pollutants, and provide fast acquisition and analysis of the 0.1-2 THz spectrum.

### BACKGROUND OF THE INVENTION

Exploration of the Terahertz (THz) frequency region of the electromagnetic spectrum (0.1 to 30 THz) conducted over several decades in scientific laboratories have revealed a spectra rich with information and opportunities. Applications for this technology range from chemical gas detection, to analysis of pharmaceutical products on the basis of their unique spectra and to imaging and inspection for hidden objects, all of which relate to certain aspects and applications of the present invention. Heretofore, the scientific equipment required for THz applications were generally laboratory-bound, bulky, fragile and expensive. The equipment generally included high-powered lasers and devices operating at liquid helium temperatures (approximately 4° Kelvin). There is a need for more compact systems that are as robust as the available laboratory systems.

### SUMMARY OF THE INVENTION

The present invention is directed to a THz instrument that is compact, moderate in cost, easy to use, operable at relatively higher temperatures and intended for use outside the laboratory. A central component of the portable THz detection system of present invention is a small THz receiver or heterodyne mixer which can receive a THz signal and convert it to a form easily processed by conventional electronics.

In one aspect, the portable THz detection system and method of the present invention provides support for a high resolution to allow the system to detect chemical species in a noisy background of pollutants, and provide fast acquisition and analysis of the 0.1-2 THz spectrum.

The compact tunable heterodyne mixer which is a core component of the disclosed invention provides a general purpose THz receiver which can be used for a wide variety of applications. The heterodyne mixer comprises a bolometer which is based on electron heating in a low-mobility channel in Aluminum Gallide Arsenide or Gallium Arsenide (AlGaAs/GaAs) which forms a two-dimensional electron gas (2DEG). Importantly, the microbolometer in an embodiment of the present invention is technologically compatible with and can be directly coupled to a THz quantum cascade laser (QCL) that is utilized as the local oscillator (LO) source. One advantage of combing a THz local oscillator with the microbolometer in a single package is the compactness of the overall design. Such a system can operate in a small footprint compared with the size of competitive sources of THz radiation. Power coupling is also significantly improved thus requiring a less powerful source of THz radiation. The wide bandwidth of the 2DEG bolometer and the narrow line width of the THz QCL enable the mixing element to have a bandwidth of greater than 10 GHz with a resolution of approximately 1 MHz, this allows the THz chemical detection system to be able to positively identify chemical species in a heavily polluted background with high confidence.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1A is a schematic diagram illustrating the system of the present in invention for a local mode of operation; and

FIG. 1B is a schematic diagram illustrating the system of the present in invention for a remote mode of operation.

### DETAILED DESCRIPTION OF A PREFERRED EMBODIMENT

This document provides and describes an overview of an exemplary environment and implementation of the present invention. Reference is made respecting chemical detection and sensing, to facilitate an understanding of the salient features and novel aspects of the invention.

The disclosed embodiment of the present invention relates to a portable high resolution THz heterodyne receiver for advanced chemical sensing. This technology utilizes a heterodyne receiver for performing THz spectroscopy on chemical species at low pressures. The heterodyne receiver comprises a Gallium arsenide (GaAs) based two-dimensional electron gas (2DEG) hot electron microbolometer (HEB) and GaAs based THz quantum cascade laser (QCL). The HEB and QCL are fabricated and coupled together on a single chip realizing a compact design for not only the THz heterodyne mixer, but also for the required cooling hardware. By utilizing the 2DEG bolometer and the THz QCL that are both GaAs, the present invention facilitates the combination and integration of the two technologies.

In one embodiment, the present invention is operable in two modes. The first mode requires a sample's spectrum to be recorded locally in a low pressure sample cell. In the second mode of operation the spectrum of the sample is recorded remotely at atmospheric temperature and pressure. The heterodyne nature of the detection mechanism allows the system to be used in a remote chemical detection mode of operation.

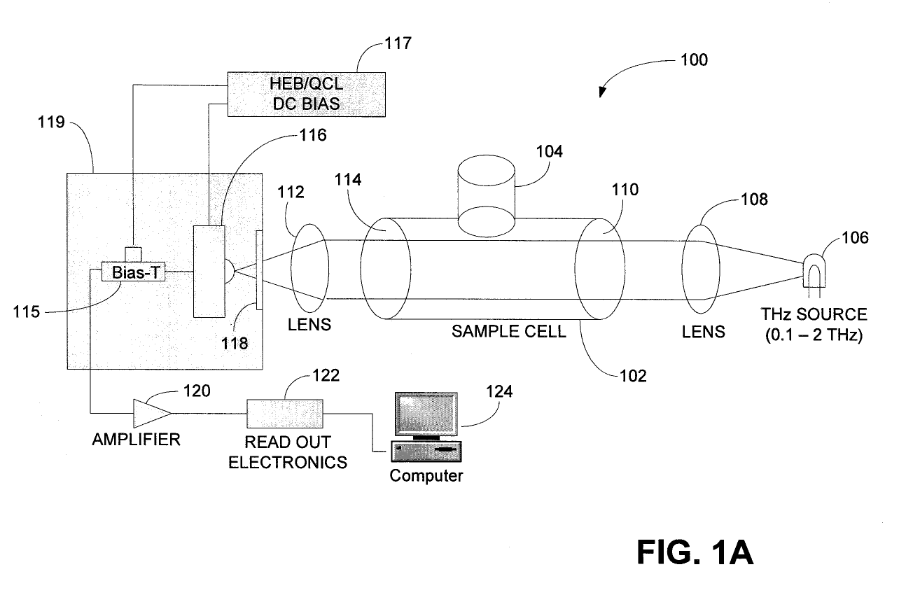

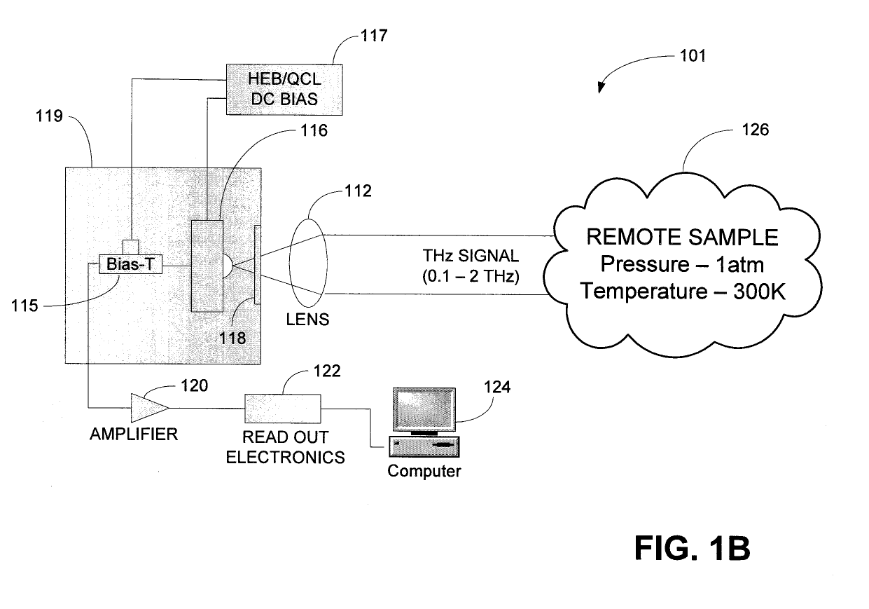

A configuration 100 for the first mode of operation is illustrated in FIG. 1A. In this first mode of operation, the absorption spectrum of the rotational and vibration modes of a sample in question is analyzed. A sample cell 102 is used to collect a sample of the atmosphere at room temperature via an inlet/evacuation port 104. The pressure within the sample cell 102 is lowered to a range of approximately 1-100 mTorr. This step enables the system to achieve narrow absorption line widths from the sample that is under analysis. The sample is radiated by a THz source. In this embodiment of the present invention and as illustrated, THz radiation is provided from a coherent broadband lamp 106. The THz radiation is dispersed through a lens 108 into a first opening 110 of said sample cell 102 to provide a wide spectrum that illuminates the sample in the cell 102. A lens 112 focuses the THz radiation emitted through a second opening 114 of the sample cell 102 onto a 2DEG HEB/QCL receiver module 116 through a Teflon window filter 118. The 2DEG HEB/QCL receiver module 116 down-converts the THz spectrum to signals in the gigahertz (GHz) frequency ranges. The down-conversion is achieved by mixing the THz signal absorbed by the component 2DEG microbolometer with the known local-oscillator signal from the component QCL. HEB/QCL DC Bias 117 provides a direct current source to bias both the microbolometer/readout electronics 122 and QCL. Bias-T 115 splits the current between the microbolometer and readout electronics 122. In one embodiment of the present invention, the Bias-T 115 and the 2DEG HEB/QCL receiver module 116 are part of a closed-cycle cryostat 119. The GHz signals from the receiver module 116 are amplified by a low noise amplifier (LNA) 120 and fed into associated readout electronics 122 to enable processing of the original spectrum by some computing device 124.

During this first mode of operation the broadband THz source 106 emits a wide spectrum covering a range of approximately 0.1-2 THz. The receiver module 116 has a bandwidth of at least 10 GHz. In order to scan the entire 0.1-2 THz spectrum and thus locate absorption lines of a sample located in the sample cell 102, the THz QCL component will scan the 0.1-2 THz spectrum in 10 GHz increments. During each one of these increments of the QCL frequency the 2DEG HEB component converts the THz signal in the 10 GHz window utilizing a high resolution that is related to the QCL component's line width (i.e. approximately 1 MHz). The THz signal is converted down to a GHz frequency suitable for processing by conventional electronics.

In the second mode of operation, which is shown in FIG. 1B as configuration 101, a remote sample 126 is analyzed. The remote sample 126 is at atmospheric pressure of 1 atm and a temperature of 300 K. The remote sample 126 is excited by thermal energy and the rotational and vibration emission of the sample in the THz range is recorded by the 2DEG HEB/QCL receiver 116. Scanning of the THz spectrum and processing of the signal is done in the same manner as described in the first mode of operation.

Specific features and advantages of the described embodiment of the present invention will be best understood by a discussion of the details of the 2DEG HEB/QCL receiver 116 and its components. An important aspect of the disclosed embodiment of the 2DEG HEB/QCL receiver 116 is the use of a 2DEG hot electron microbolometer component and a QCL component. The 2DEG microbolometer requires an operating temperature of only 77 K compared with competitive superconducting bolometers that need about 4 K temperature. Furthermore, the 2DEG HEB requires only approximately 10 μW from a local oscillator compared with room temperature Schottky diode mixers which typically require milliwatts of power.

Because of negligible phonon overheating in the two dimensional electron gas −2DEG, the HEB is able to provide a fast response (THz range) and is able to operate at moderate temperatures (˜77 K). The detection mechanism of 2 DEG HEB may be described as follows: THz radiation heats the 2D electron gas in the sensor and changes its mobility, which in turn changes the bolometer resistance which can be measured by the electronic readout. The sensitivity of this detector is a result of the small number of electrons in the microscale volume which undergo a substantial temperature rise when exposed to the weak THz radiation.

The 2DEG HEB mixer of the present invention has several distinct features making it especially suitable for THz detection as implemented in the present invention:

High sensitivity (low noise): When the device is properly coupled to an antenna and read-out electronics, the Noise Equivalent Power (NEP) will be determined by the absolute fluctuation of electron temperature, which is proportional to the electron heat capacity of the 2DEG in the conducting channel. The resulting high sensitivity, which is comparable with the sensitivity of superconducting detectors, previously considered the most sensitive, is achieved because of the ultra-small heat capacity of the 2D-electron gas in the microscale volume.

Broad spectral coverage: The technology can be extended towards both the lower and upper frequency ends of the spectrum: from 0.1 THz to 30 THz. This frequency span is set by the electron cooling rate and by the operating range of planar antennas. For gas monitoring, the range of 0.1 to 2 THz may be adequate.

Low local oscillator power: Because of the small electron heat capacity of the sensor, the proposed mixer requires only a low power local oscillator (LO). Thus, an available solid state LO, rather than the large, currently used THz laser, may be used in combination with the microbolometer.

Low cost and available fabrication technologies: The hot-electron microbolometer is fabricated on a bulk substrate using standard photolithography techniques. It simplifies the fabrication procedure, increases the yield, and makes the detector much more robust and reliable. A large array of elements can be fabricated on a single wafer, with a few lithographic steps.

Technological compatibility of the mixer and local oscillator: The same technologies can be used to fabricate the THz detector and a solid-state local oscillator (LO), i.e. the quantum cascade laser. Thus, the basic components of THZ remote sensing system (microbolometer and LO), can be mounted together, and other embodiments, fabricated on the same chip.

Moderate cooling requirements: The required operation at reduced temperatures (77° K) may be achieved by utilizing available, relatively compact closed-cycle refrigerators.

Impedance matching to antenna and Intermediate Frequency (IF) amplifier: The hot-electron microbolometer may be readily matched to a planar antenna at the input of the mixer and to the following IF amplifier because the device impedance will be in the range 50-200Ω (and the microbolometer size is much smaller than the wavelength).

Feasibility for imaging applications: The mixer pixel size will be determined by its microantenna, which will be on the order of the wavelength. Therefore, the fabrication technology will enable larger format detector arrays for future imaging applications.

One major problem with traditional solid state THz sources is that they produce very low power in the micro Watts range. Better results for high power operations can be accomplished by THz QCLs having output powers in approximately the 1 milliwatt range. The quantum cascade laser (QCL) of the present invention is a semiconductor based laser whose emission wavelength is entirely defined by quantum confinement. Thus, the spectral properties can be engineered in a wide frequency region spanning over the Mid Infra Red (MIR) and THz spectral range. As a result, compact sources of coherent radiation may be utilized as local oscillators for heterodyne detection systems. A stable continuous-wave single-mode operation is required with high output powers in the milliwatt region. The present invention provides QCLs that are made from GaAs based technologies and provide the power features described earlier. The THz QCL of the present invention can also be operated at 77 K with reasonable output powers. In addition to the other properties described above, the GaAS QCL of the present invention provides compatibility with the 2DEG HEB described earlier. The combination of the 2DEG HEB and the QCL results in the heterodyne detection system of the present invention.

An advantage of utilizing a heterodyne detection in the THz chemical detection system of the present invention is to allow for high resolution scans limited primarily by the line width of the QCL (˜1 MHz), fast acquisition times limited by the bandwidth of the 2DEG HEB (˜10 GHz), and compact design limited by the cooling system size. For 77 K closed cycle cryocoolers the dimensions of the overall device may be one cubic foot (1 ft³). The use of a 2DEG HEB and coupled QCL in the same package as provided by the present invention achieves this unique solution and technology.

In operation, the portable THz detection system and method of the present invention provides significant advantages for the remote monitoring of public and industrial facilities for toxic industrial chemicals, chemical agents, and explosives. The portable system can provide critical information on the status of an environment, aid in the demarcation of pollutants, and monitor the progress of cleanup efforts. Essential features of the THz chemical sensing system of the present invention are a high resolution to allow the system to detect chemical species in a noisy background of pollutants, and fast acquisition and analysis of the 0.1-1 THz spectrum. The compact tunable heterodyne mixer which makes up the core of this disclosed invention provides a general purpose THz receiver which can be used in a wide variety of applications.

Further still, the receiver of the present invention addresses both federal government (Department of Homeland Security, NASA, and DOE) and commercial applications related to remote chemical and biological sensing. The system can provide information on the concentration of environmental gases, aid in the demarcation of pollutions, and monitor the progress of cleanup efforts. The system of the present invention is flexible and could be applied to a variety of chemical and biological contaminants.

In other embodiments of the present invention, the receiver element 116 may also be used as an imager for screening of personnel and handheld materials because of its ability to detect the composition, size, and shape of materials through the characteristic transmission or reflectivity spectra. The THz screening is non-invasive and non-destructive for living beings. Explosives and biological agents can be detected and identified even if concealed within clothing and suitcases, because the THz radiation is transmitted through clothing and luggage.

Many opportunities abound for the THz sensing of the present invention in modern medicine. With specific contrast mechanisms, THz radiation has a potential to provide imaging of biological materials with sub-millimeter resolution on the surface of bodies and at depths to about 1 cm in tissue.

While this method and apparatus has been shown and described with reference to certain preferred embodiments thereof, it will be understood by those skilled in the art that various changes in form and details may be made therein without departing from the spirit and scope of the invention as described.

What is claimed is:

1. A portable high resolution terahertz receiver for chemical sensing comprising:
a two-dimensional electron gas hot electron microbolometer (2DEG HEB); and
a quantum cascade laser (QCL);
wherein said microbolometer and said quantum cascade laser are coupled together in a single package;
said portable receiver having high resolution scans limited by the line width of the quantum cascade laser;
said portable receiver having acquisition times limited by the bandwidth of the microbolometer;
said portable receiver having a compact design limited by the cooling system size.

2. The portable terahertz receiver of claim 1 wherein said two-dimensional electron gas hot electron microbolometer and said quantum cascade laser are both Gallium Arsenic based.

3. The portable terahertz receiver of claim 2 wherein said terahertz receiver is adapted to down convert a terahertz frequency spectrum to a gigahertz frequency range to provide one or more output signals; wherein said down converting is provided by mixing an absorbed one of said terahertz frequency spectrum frequency with a known local oscillator signal from said quantum cascade laser; and wherein said one or more output signals is amplified by a low noise amplifier for processing of said terahertz frequency spectrum.

4. The portable terahertz receiver of claim 3 wherein said quantum cascade laser scans said terahertz frequency spectrum in approximately 10 GHz increments.

5. The portable terahertz receiver of claim 4 adapted to analyze a sample having an atmospheric pressure of approximately 1 atm and a temperature of approximately 300 Deg. Kelvin, wherein said sample is excited by thermal energy and said portable terahertz receiver thereby records rotational and vibration emissions of said sample.

6. The portable terahertz receiver of claim 4 adapted to analyze a sample collected by a sample cell, said sample cell collecting said sample at room temperature and lowering pressure a range of approximately 1-100 m Torr; whereby narrow absorption line widths of said sample are provided; wherein said sample is radiated by a terahertz source onto said portable terahertz receiver.

7. The portable terahertz receiver of claim 3 adapted for use as an imager for screening of personnel or handheld materials utilizing characteristic transmission or reflectivity spectra of said screened personnel or materials.

8. A compact tunable heterodyne mixer for providing a general purpose THz receiver, said mixer comprising:
a bolometer, said bolometer providing electron heating in a low-mobility channel in AlGaAs/GaAs to form a two-dimensional electron gas (2DEG); and
a local oscillator (LO) source, wherein said local oscillator source is a THz quantum cascade laser (QCL);
wherein said bolometer and said quantum cascade laser are directly coupled together in a single package.

9. The tunable mixer of claim 8 wherein said bolometer has a wide bandwidth and said quantum cascade laser has a narrow line width, wherein said tunable mixer has a bandwidth of greater than 10 GHz with a resolution of approximately 1 MHz to thereby provide positive identification of chemical species in a heavily polluted background.

10. The heterodyne mixer of claim 8 wherein said terahertz receiver is adapted to down convert a terahertz frequency spectrum to a gigahertz frequency range to provide one or more output signals; wherein said down converting is provided by mixing an absorbed one of said terahertz frequency spectrum frequency with a known local oscillator signal from said quantum cascade laser; and wherein said one or more output signals is amplified by a low noise amplifier for processing of said terahertz frequency spectrum.

11. The portable terahertz receiver of claim 10 wherein said quantum cascade laser scans said terahertz frequency spectrum in approximately 10 GHz increments.

12. The portable terahertz receiver of claim 10 adapted to analyze a sample collected by a sample cell, said sample cell collecting said sample at room temperature and lowering pressure a range of approximately 1-100 m Torr; whereby narrow absorption line widths of said sample are provided; wherein said sample is radiated by a terahertz source onto said portable terahertz receiver.

13. A portable high resolution terahertz receiver component of a closed cycle cryocooler, comprising:
a two-dimensional electron gas hot electron microbolometer (2DEG HEB) having a bandwidth of approximately 10 GHz; and
a quantum cascade laser (QCL) having line width of approximately 1 MHz;
wherein said microbolometer and said quantum cascade laser are coupled together in a single package;
said portable receiver having high resolution scans limited by the line width of the quantum cascade laser;
said portable receiver having acquisition times limited by the bandwidth of the microbolometer;
said portable receiver having a compact design limited by the cyrocooler size;
said terahertz receiver adapted to receive terahertz radiation emitted from an illuminated or excited sample, to thereby convert the received spectrum of terahertz radiation to signals in the gigahertz frequency range.
